(19) United States
(12) Patent Application Publication
(10) Pub. No.: US 2024/0208847 A1
(43) Pub. Date: Jun. 27, 2024

(54) DEGRADABLE WASTE PROCESSING

(71) Applicants: Ruby LAI, Palo Alto, CA (US); THE TRUSTEES OF COLUMBIA UNIVERSITY IN THE CITY OF NEW YORK, New York, NY (US)

(72) Inventor: Ruby LAI, Palo Alto, CA (US)

(73) Assignee: THE TRUSTEES OF COLUMBIA UNIVERSITY IN THE CITY OF NEW YORK, New York, NY (US)

(21) Appl. No.: 18/287,557

(22) PCT Filed: Apr. 20, 2022
(86) PCT No.: PCT/US22/25556

§ 371 Date: Oct. 19, 2023

Related U.S. Application Data
(60) Provisional application No. 63/308,107, filed on Feb. 9, 2022.
(60) Provisional application No. 63/177,118, filed on Apr. 20, 2021.

(51) Int. Cl. C02F 3/34; C02F 3/02

(52) U.S. Cl. CPC C02F 3/341; C02F 3/02; C02F 2203/006; C02F 2209/08; C02F 2209/38; C02F 2301/106

(57) ABSTRACT

An amount of a first reactant, such as degradable wastes like stool and toilet paper from waste disposal systems, is provided as a liquid influent to a reactor. A gaseous influent stream providing a second reactant, e.g., air, is also provided for reaction with the first reactant. The reaction produces a solvent-laden gaseous effluent that is removed. The reactor can include a plurality of thermophilic bacteria with the influent stream of air configured to aerate the biomass and enable aerobic digestion of wastes. Solvent in the removed effluent, e.g., water, can then be condensed and isolated therefrom. Condensate isolated in this manner has been shown in achieve at least 28 mg/L chemical oxygen demand (COD) and 1.2 mg/L total suspended solids (TSS) from consumer human waste influent. The effluent can be recycled to achieve nearly the same rate of COD removal at greatly reduced power consumption.

### CROSS REFERENCE TO RELATED APPLICATION(S)

This application is a national stage filing of International Patent Application No. PCT/US2022/025556, filed Apr. 20, 2022, which claims the benefit of U.S. Provisional Applications No. 63/177,118, filed Apr. 20, 2021, and 63/308,107, filed Feb. 9, 2022, which are incorporated by reference as if disclosed herein in their entirety.

### BACKGROUND

About 2 billion tons of municipal wastes, including organic solid wastes, are currently generated each year. Processing of these wastes and recovering resources therefrom is an emerging research area, with an overall goal of reversing the accumulation of waste material, reducing waste processing costs, and improving the efficiency of ancillary processes and products with materials recycled from these wastes. Of particular concern is the processing of human waste, the disposal of which presents a logistical issue particularly in densely populated areas, and the failure of which to do so properly can have severe local environmental and health impacts.

Even modern systems for addressing the processing of degradable wastes such as human waste have significant drawbacks that call into question the long-term viability of those system as a whole, whether that be because of energy inefficiency, spatial inefficiency, the use of harsh chemicals, etc. One such system commonly used for degradable waste solid-liquid separation utilizes settling, e.g., sedimentation, but this process requires chemical flocculants and produces low quality effluent. Another such system is the use of membrane bioreactors for separation of solid and liquid waste, but the main challenge is the fouling of the membrane and high cost of membrane materials.

What is desired, therefore, are simplified systems and methods that can be scaled to process streams including degradable material for reuse or easy disposal, and for these systems and methods to be suitably efficient so they could be operated cost-effectively and with little to no environmental impact.

### SUMMARY

Aspects of the present disclosure are directed to a reactor system for processing reactants. In some embodiments, the reactor system simultaneously separates reaction products or solvent from the reactor. In some embodiments, the system includes a reactor including an internal reactor volume, a first inlet in fluid communication with the internal reactor volume, the first inlet configured to receive a liquid influent stream including a first reactant, at least one outlet in fluid communication with the internal reactor volume, the at least one outlet configured to remove a first gaseous effluent stream including an amount of solvent vapor, and a second inlet in fluid communication with the internal reactor volume, the second inlet configured to receive a gaseous influent stream including a second reactant. In some embodiments, the system includes a biomass positioned in the internal reactor volume, a porous substrate positioned between the second inlet and the biomass, a liquid influent stream in fluid communication with the first inlet, the liquid influent stream including an aqueous composition and the first reactant including one or more degradable components, a first gaseous effluent stream in fluid communication with the at least one outlet, the solvent vapor including water, and a gaseous influent stream in fluid communication with the second inlet, the gaseous influent stream including a gas composition including the second reactant, the second reactant including oxygen. In some embodiments, the reactor system lacks a separation system, e.g., a clarifier, membrane, etc., after the outlets. In some embodiments, the reactor system lacks a separation system, e.g., a clarifier, membrane, etc., after a reactor fluid outlet. In some embodiments, the reactor system lacks a separation system for use following reaction of the reactants.

In some embodiments, the porous substrate includes a plurality of orifices having an average diameter between about 1 mm and about 300 mm. In some embodiments, the degradable components include stool, toilet paper, urine, food waste, industrial waste, agricultural waste, or combinations thereof. In some embodiments, the gas composition includes air, pure oxygen, or combinations thereof. In some embodiments, the gas composition includes a fresh gas stream, at least a portion of the first gaseous effluent stream, or combinations thereof. In some embodiments, the biomass includes a plurality of thermophilic bacteria. In some embodiments, the thermophilic bacteria include firmicutes, deinococcus-thermus, proteobacteria, gemmatimonadetes, chloroflexi, bacteroidetes, actinobacteria, cyanobacteria, verrucomicrobia, acidobacteria, planctomycetes, euryarchaeota, or combinations thereof. In some embodiments, the temperature in the internal reactor volume is maintained between about 40° C. and about 80° C.

In some embodiments, the system includes a condenser in fluid communication with the at least one outlet, the condenser including a liquid condenser outlet configured to remove from the condenser an amount of a liquid component including an amount of solvent vapor, and a gaseous condenser outlet configured to remove from the condenser an amount of a gaseous component including an amount of a first gaseous effluent stream. In some embodiments, the gaseous condenser outlet is in fluid communication with the internal reactor volume.

Aspects of the present disclosure are directed to a system for processing degradable waste, the system include a reactor including a bubble distributor positioned within the reactor and defining an internal reactor volume between the bubble distributor and an opposing end of the reactor, the bubble distributor including a plurality of substantially evenly distributed orifices extending therethrough, the orifices having a diameter between about 1 mm and about 300 mm, a first inlet in fluid communication with the internal reactor volume, at least one outlet in fluid communication with the internal reactor volume, a second inlet in fluid communication with the internal reactor volume, and a biomass positioned in the internal reactor volume, the biomass including a plurality of thermophilic bacteria. In some embodiments, the system includes a first influent stream in fluid communication with the first inlet, the first influent stream including an aqueous composition including one or more degradable components, a first gaseous effluent stream in fluid communication with the at least one outlet, the first gaseous effluent stream including an amount of water vapor, a second influent stream in fluid communication with the second inlet, the second influent stream including a gas composition including an oxygen component, a heat source configured to maintain the internal reactor volume at a temperature between about 40° C. and about 80° C., a condenser in fluid communication with the first gaseous effluent stream, a liquid condenser outlet stream in fluid communication with the condenser, the liquid condenser stream including an amount of a liquid component isolated from the first gaseous effluent stream and having a chemical oxygen demand less than about 30 mg/L, and a gaseous condenser outlet stream in fluid communication with the condenser and the second influent stream, the gaseous condenser stream comprising a gaseous component isolated from the first gaseous effluent stream, wherein the second influent stream includes the gaseous condenser outlet stream and an amount of air.

In some embodiments, the thermophilic bacteria include firmicutes, deinococcus-thermus, proteobacteria, gemmatimonadetes, chloroflexi, bacteroidetes, actinobacteria, cyanobacteria, verrucomicrobia, acidobacteria, planctomycetes, euryarchaeota, or combinations thereof. In some embodiments, an oxygen transfer rate to the biomass is equal to or greater than the accumulating biological oxygen demand of the internal reactor volume. In some embodiments, a flow rate of the water vapor in the first gaseous effluent stream is equal to or greater than a flow rate of the first influent stream.

Aspects of the present disclosure are directed to a method for processing degradable waste. In some embodiments, the method includes providing a reactor, the reactor including an internal reactor volume, a first inlet in fluid communication with the internal reactor volume, at least one outlet in fluid communication with the internal reactor volume, a second inlet in fluid communication with the internal reactor volume, a biomass positioned in the internal reactor volume, and a porous substrate positioned between the second inlet and the biomass. In some embodiments, the method includes flowing a first influent stream to the internal reactor volume via the first inlet, the first influent stream including a liquid composition including one or more degradable components. In some embodiments, the method includes flowing a second influent stream to the internal reactor volume via the second inlet and through the porous substrate, the second influent stream including a gas composition including one or more reactants. In some embodiments, the method includes reacting the one or more degradable components with the one or more reactants. In some embodiments, the method includes flowing a first effluent stream from the internal reactor volume via the at least one outlet, the first effluent stream including an amount of a solvent vapor. In some embodiments, the method includes flowing at least a portion of the first effluent stream to a condenser. In some embodiments, the method includes condensing a liquid condenser outlet stream from the first effluent stream. In some embodiments, the method includes isolating the liquid condenser outlet stream from a gaseous condenser outlet stream. In some embodiments, the method includes combining at least a portion of the gaseous condenser outlet stream with the second influent stream, wherein the one or more reactants include oxygen.

In some embodiments, the porous substrate includes a plurality of orifices having an average diameter between about 1 mm and about 300 mm. In some embodiments, the degradable components include stool, toilet paper, urine, food waste, industrial waste, agricultural waste, or combinations thereof. In some embodiments, the biomass includes a plurality of thermophilic bacteria including firmicutes, deinococcus-thermus, proteobacteria, gemmatimonadetes, chloroflexi, bacteroidetes, actinobacteria, cyanobacteria, verrucomicrobia, acidobacteria, planctomycetes, euryarchaeota, or combinations thereof.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic representation of a system for processing reactants according to some embodiments of the present disclosure;

FIG. 2A is a schematic representation of a system for processing degradable waste according to some embodiments of the present disclosure;

FIG. 2B is a schematic representation of a system for processing degradable waste according to some embodiments of the present disclosure;

FIG. 2C is a schematic representation of a system for processing degradable waste according to some embodiments of the present disclosure;

FIG. 2D is a schematic representation of a system for processing degradable waste according to some embodiments of the present disclosure;

FIG. 2E is a schematic representation of a system for processing degradable waste according to some embodiments of the present disclosure;

FIG. 3 is a chart of a method for processing reactants according to some embodiments of the present disclosure;

FIG. 4A is a chart of a graph showing the total chemical oxygen demand (TCOD) of an influent waste stream and an effluent product stream from a reactor of a system for processing degradable waste according to some embodiments of the present disclosure operated over time; and

FIG. 4B is a chart of a graph showing the TCOD in the reactor of a system for processing degradable waste according to some embodiments of the present disclosure operated over time.

### DETAILED DESCRIPTION

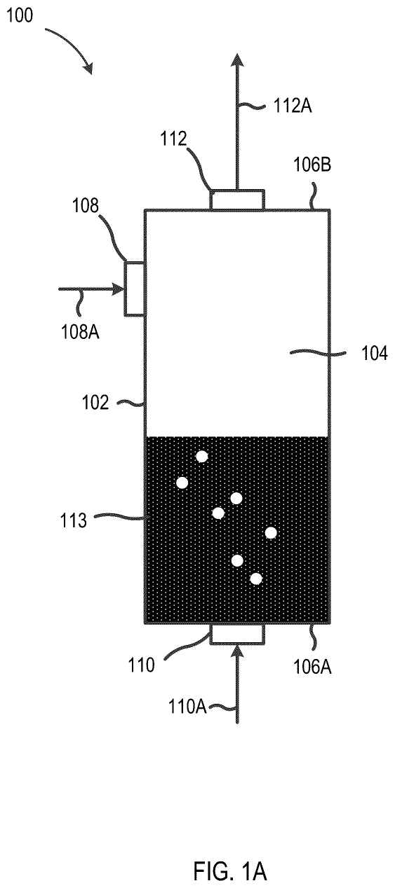

Referring now to FIG. 1, some embodiments of the present disclosure are directed to a system 100 for processing one or more reactants. In some embodiments, system 100 includes a reactor 102. Reactor 102 can be of any suitable size and shape to receive a volume of reactants from one or more influent streams, facilitate the reaction thereof, and remove one or more effluent streams in a continuous, semi-continuous, or batch process, as will be discussed in greater detail below. Reactor 102 can also be composed of any material or combination of materials suitable for use with the reactants and for facilitating the reaction thereof. In some embodiments, system 100 includes a plurality of reactors 102. In some embodiments, the plurality of reactors 102 process generally the same reactants, i.e., receive reactant influent streams from the same source or the same type of source, e.g., one or more human or municipal waste streams. In some embodiments, the plurality of reactors 102 process a two or more different combinations of reactants, i.e., receive influent streams from different sources, different types of sources, in different combinations, etc.

In some embodiments, reactor 102 includes an internal reactor volume 104. As discussed above, internal reactor volume 104 can be of any suitable volume to receive influent streams including the reactants to be reacted, facilitate reaction thereof, and further facilitate the removal of one or more effluent streams therefrom, as will be discussed in greater detail below. In some embodiments, reactor 102 includes a first end 106A and a second end 106B, with internal reactor volume 104 disposed therebetween.

In some embodiments, reactor 102 includes a plurality of inlets and outlets in fluid communication with internal reactor volume 104. In some embodiments, reactor 102 includes a first inlet 108. First inlet 108 is configured to receive a liquid influent stream, e.g., 108A, that includes a first reactant. In some embodiments, reactor 102 includes a second inlet 110. Second inlet is configured to receive a gaseous influent stream, e.g., 110A, including a second reactant. In some embodiments, reactor 102 includes one or more additional inlets (not pictured) configured to receive additional influent streams including additional reactants. Reactor inlets, e.g., 108, 110, etc., can be of any suitable size and shape to receive influent streams from a source and facilitate transmission of those influent streams to internal reactor volume 104. Reactor inlets can also include any suitable additional components to facilitate and control receipt and transmission of influent streams, e.g., one or more valves, baffles, sieves, heaters, coolers, etc., or combinations thereof. By way of example, first inlet 108 may be configured specifically to receive and transmit to internal reactor volume 104 a liquid flush volume from a consumer toilet including an amount of stool and toilet paper, while second inlet 110 may be configured specifically to receive and transmit to internal reactor volume 104 a gaseous stream of air and/or pure oxygen at a predetermined flow rate.

In some embodiments, reactor 102 includes at least one outlet 112. Outlets 112 is configured to remove effluent streams, e.g., 112A, from reactor 102. In some embodiments, at least one outlet 112 is configured to remove a gaseous effluent stream from reactor 102. In some embodiments, at least one outlet 112 is configured to remove a gaseous effluent stream 112A from reactor 102 that includes an amount of solvent vapor. In some embodiments, reactor 102 includes one or more additional outlets (not pictured) configured to remove additional effluent streams. As discussed above with respect to the inlets, reactor outlets, e.g., 112, can be of any suitable size and shape to receive effluent streams from reactor 102, e.g., from internal reactor volume 104, and facilitate transmission of the effluent streams out of the reactor. Reactor outlets can also include any suitable additional components to facilitate and control receipt and transmission of those effluent streams from reactor 102, e.g., one or more valves, baffles, sieves, heaters, coolers, etc., or combinations thereof. By way of example, outlet 112 may be configured specifically to receive and transmit out of internal reactor volume 104 a stream of humid air.

In some embodiments, reactor 102 is oriented vertically or substantially vertically. In some embodiments, outlet 112 is positioned at or near the top of reactor 102 to aid in removal of gaseous compositions from internal reactor volume 104. In some embodiments, outlet 112 is positioned on or proximate second end 106B. In some embodiments, second inlet 110 is positioned on or proximate first end 106A. In some embodiments, first outlet 108 is positioned in reactor 102 between first end 106A and second end 106B.

As liquid influent streams and gaseous influent streams are brought into reactor 102, e.g., via first inlet 108 and second inlet 110, reactants from those streams are contacted in internal reactor volume 104, e.g., at volume 113, and undergo corresponding chemical reactions. As the feeding of the influent streams and chemical reactions continues, reaction products are evolved. Further, a gaseous component including solvent vapor is evolved. In some embodiments, the gaseous component in internal reactor volume 104 includes one or more reaction products. In some embodiments, the solvent vapor in the gaseous component includes solvent provided by one of the influent streams, solvent evolved from the chemical reactions in internal reactor volume 104, or combinations thereof. As will be discussed in exemplary embodiments below, in some embodiments, the solvent vapor is water vapor. The gaseous component including the evaporated solvent is then removed from internal reactor volume 104 via outlet 112, so that internal reactor volume 104 is capable of being dried simultaneously with evolution of reaction products. In some embodiments, system 100 lacks a separate separation system, e.g., clarifier, membrane, etc., positioned after outlets 112. In some embodiments, system 100 lacks a separate separation system positioned at a reactor fluid outlet. In some embodiments, the gaseous component is recycled back to reactor 102, e.g., via second inlet 110, as will be discussed in greater detail below. In some embodiments, one or more products are isolated from the gaseous component.

In some embodiments, reactor 102 is in fluid communication with one or more reactant sources to provide the liquid and gaseous influent streams including the reactants for reaction in internal reactor volume 104. In some embodiments, the reactants are any suitable combination of reactants suitable for generating a desired reaction product or products. In some embodiments, the reactants in the liquid influent stream include waste materials, e.g., from waste disposal systems, industrial processes, recovered from the environment, etc., or combinations thereof. In some embodiments, the reactants include one or more degradable materials. In some embodiments, the degradable materials include stool, toilet paper, urine, food waste, industrial waste, agricultural waste, or combinations thereof. In some embodiments, gaseous influent streams include one or more gasses for reacting with reactants in the liquid influent streams, e.g., one or more degradable materials. In some embodiments, the gaseous influent streams include a concentration of solvent vapor. In some embodiments, the gaseous influent streams include air, pure or substantially pure gaseous elements or compounds, waste effluent, e.g., from an industrial process, etc., or combinations thereof.

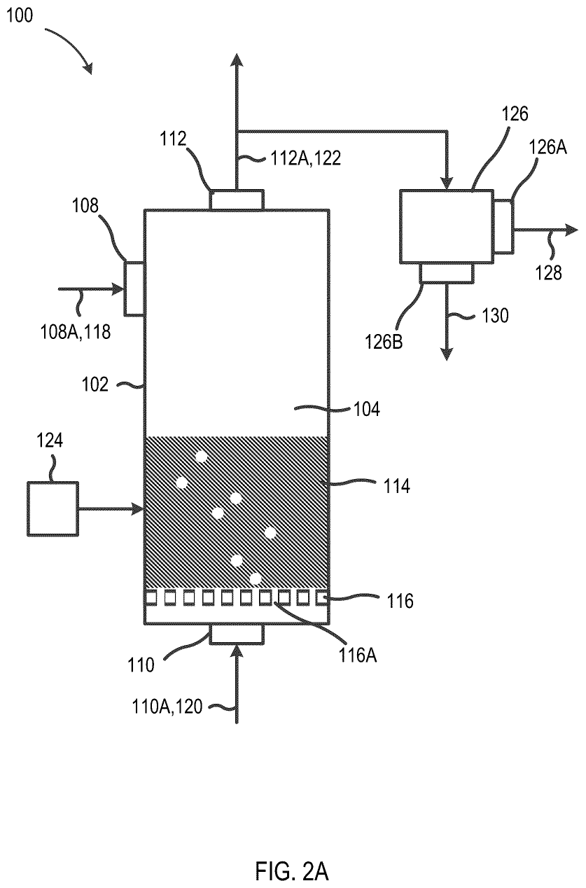

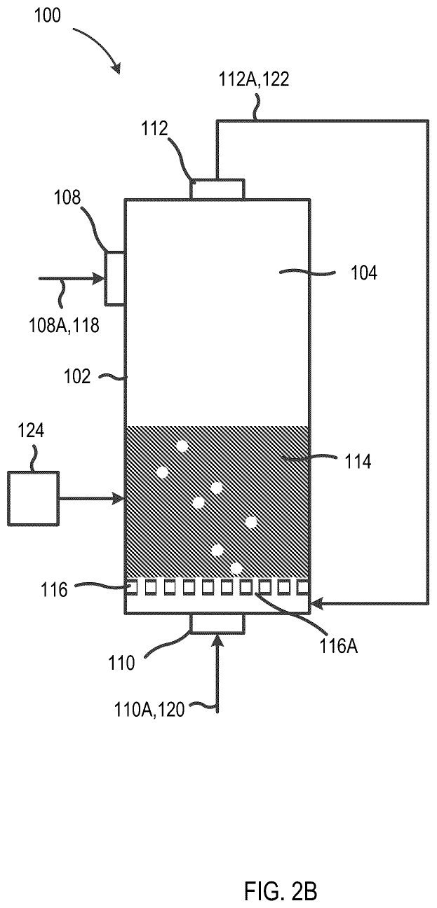

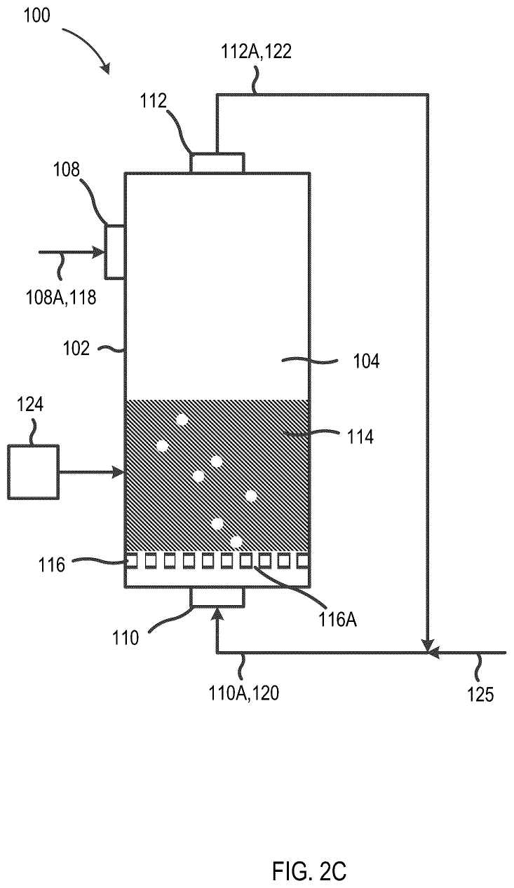

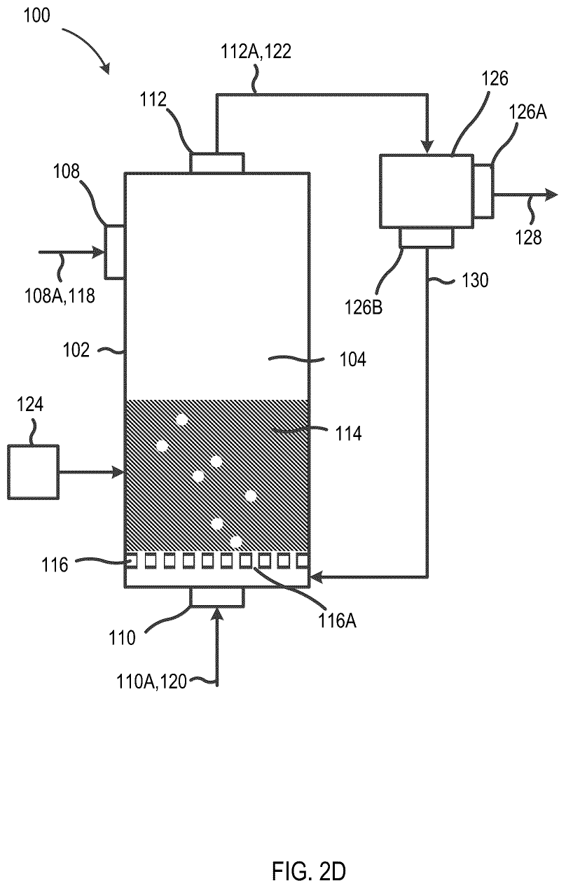

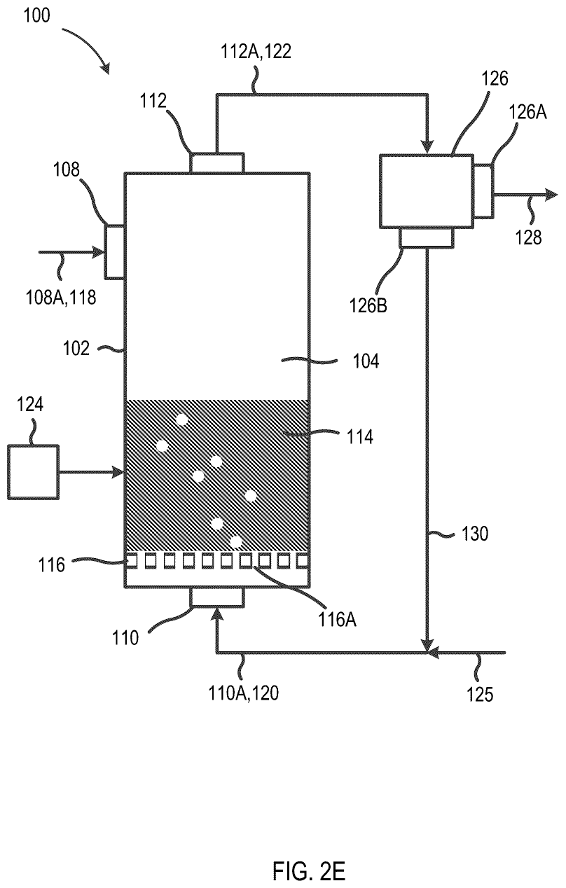

Referring now to FIGS. 2A-2E, exemplary embodiments of system 100 are shown. The embodiments depicted in these figures are configured for the processing of human wastes, although the components depicted herein are not necessarily limited to use for this specific embodiment, use-case, and reactants, and further are consistent with the embodiments of system 100 as shown and described with respect to FIG. 1.

Referring specifically to FIG. 2A, in some embodiments, system 100 includes a biomass 114. In some embodiments, biomass 114 is positioned in internal reactor volume 104. In some embodiments, biomass 114 is configured to react with or catalyze the reaction of reactants in internal reactor volume 104, as will be discussed in greater detail below. In some embodiments, biomass 114 includes a one or more different species of bacteria. In some embodiments, biomass 114 includes one or more species of thermophilic bacteria. In some embodiments, biomass 114 includes a plurality of thermophilic bacteria. In some embodiments, the thermophilic bacteria include firmicutes, deinococcus-thermus, proteobacteria, gemmatimonadetes, chloroflexi, bacteroidetes, actinobacteria, cyanobacteria, verrucomicrobia, acidobacteria, planctomycetes, euryarchaeota, or combinations thereof. The mass and efficiency of biomass 114 is suitable for the intended reaction or catalysis of the intended reaction and generation of the intended reaction products, as will be discussed in greater detail below.

In some embodiments, a porous substrate 116 is positioned between second inlet 110 and biomass 114. Porous substrate 116 is configured to distribute gaseous influent streams to internal reactor volume 104. In some embodiments, porous substrate also limits backflow towards or into second inlet 110. In some embodiments, porous substrate 116 is a bubble distributor positioned within reactor 102, defining internal reactor volume 104 between the bubble distributor and an opposing end of the reactor, e.g., end 106B. In some embodiments, porous substrate 116 includes a plurality of orifices 116A extending therethrough. In some embodiments, the plurality of orifices 116A are substantially evenly distributed. In some embodiments, orifices 116A have a diameter or an average diameter greater than about 0.5 mm. In some embodiments, orifices 116A have a diameter or an average diameter greater than about 1 mm. In some embodiments, orifices 116A have a diameter or an average diameter greater than about 2 mm. In some embodiments, orifices 116A have a diameter or an average diameter greater than about 5 mm. In some embodiments, orifices 116A have a diameter or an average diameter greater than about 10 mm. In some embodiments, orifices 116A have a diameter or an average diameter greater than about 20 mm. In some embodiments, orifices 116A have a diameter or an average diameter greater than about 50 mm. In some embodiments, orifices 116A have a diameter or an average diameter greater than about 75 mm. In some embodiments, orifices 116A have a diameter or an average diameter greater than about 100 mm. In some embodiments, orifices 116A have a diameter or an average diameter greater than about 150 mm. In some embodiments, orifices 116A have a diameter or an average diameter greater than about 200 mm. In some embodiments, orifices 116A have a diameter or an average diameter greater than about 300 mm. In some embodiments, orifices have a diameter or an average diameter between about 0.5 mm and about 350 mm. In some embodiments, orifices 116A have a diameter or an average diameter between about 1 mm and about 300 mm. In some embodiments, orifices 116A have a diameter or an average diameter between about 1 mm and about 100 mm. In some embodiments, orifices 116A have a diameter or an average diameter between about 1 mm and about 10 mm. In some embodiments, orifices 116A have a diameter or an average diameter of about 1 mm.

Still referring to FIG. 2A, in some embodiments, a first influent stream 118 is in fluid communication with first inlet 108. In some embodiments, first influent stream 118 is a liquid influent stream including a first reactant. In some embodiments, first influent stream 118 includes an aqueous composition. In some embodiments, first influent stream 118 includes an organic solvent. As discussed above, in some embodiments, the first reactant includes one or more degradable components. In some embodiments, the degradable components include stool, toilet paper, urine, food waste, industrial waste, agricultural waste, or combinations thereof.

In some embodiments, a second influent stream 120 is in fluid communication with second inlet 110. In some embodiments, second influent stream 120 is a gaseous influent stream including a second reactant. In some embodiments, second influent stream includes a gas composition. As discussed above, in some embodiments, the second reactant is configured to have a desired reaction with the first reactant. In the exemplary embodiment of FIGS. 2A-2E, the desired reaction is degradation of the degradable components, e.g., waste materials, in first influent stream 118. In the exemplary embodiment, the second reactant includes oxygen. In some embodiments, the gas composition includes air, pure oxygen, or combinations thereof. In some embodiments, biomass 114 catalyzes the degradation reactions of the degradable components from first influent stream 118.

In some embodiments, a first effluent stream 122 is in fluid communication with outlet 112. In some embodiments, first effluent stream 122 is a gaseous effluent stream. In some embodiments, first effluent stream 122 includes an amount of solvent vapor. In some embodiments, the solvent vapor includes water.

In some embodiments, system 100 includes a heat source 124. In some embodiments, heat source 124 provides heat to the reactants in internal reactor volume 104. In some embodiments, heat source 124 is configured to maintain internal reactor volume 104 at a temperature above about 40° C. In some embodiments, heat source 124 is configured to maintain internal reactor volume 104 at a temperature above about 50° C. In some embodiments, heat source 124 is configured to maintain internal reactor volume 104 at a temperature above about 60° C. In some embodiments, heat source 124 is configured to maintain internal reactor volume 104 at a temperature above about 70° C. In some embodiments, heat source 124 is configured to maintain internal reactor volume 104 at a temperature above about 80° C. In some embodiments, heat source 124 is configured to maintain internal reactor volume 104 at a temperature between about 40° C. and about 80° C. In some embodiments, heat source 124 is configured to maintain internal reactor volume 104 at a temperature between about 50° C. and about 70° C. In some embodiments, heat source 124 is configured to maintain internal reactor volume 104 at a temperature of about 60° C.

In this exemplary embodiment, first influent stream 118 provides, e.g., a liquid stream including the flush volume from one or more toilets and solid wastes such as stool and toilet paper to internal reactor volume 104. Simultaneously, second influent stream 120 provides a stream of gas including oxygen, e.g., air, to internal reactor volume 104 via porous substrate 116. The porous substrate distributes the gas, e.g., into coarse bubbles, which act to aerate biomass 114 and mix the reactants and the biomass. The degradable materials from first influent stream 118 are thus aerobically degraded at biomass 114. First effluent stream 122 is also generated, including unreacted gas from second influent stream 120 and an amount of solvent in the form of water vapor, the water coming in part from first influent stream 118 and in part from the aerobic degradation of the solid wastes. First effluent stream 122 can then be removed from reactor 102 to help dry internal reactor volume 104 and allow the reactor to operate at or near steady state, i.e., the liquid entering the reactor from the influent streams is balanced by the removal of solvent-laden effluent streams.

Referring now to FIGS. 2B-2E, in some embodiments, first effluent stream 122 is recycled. In some embodiments, first effluent stream 122 is recycled directly to reactor 102 (see FIG. 2B). In some embodiments, first effluent stream 122 is recycled to second influent stream 120. In these embodiments, the gas composition of second influent stream 120 includes a fresh gas stream, e.g., that has not yet been mixed with the reactor fluid (see stream 125 from FIGS. 2C and 2E), at least a portion of first effluent stream 122, or combinations thereof. In some embodiments, second influent stream 120 is composed of between about 5% and about 25% fresh gas to recycled first effluent stream 122. In some embodiments, second influent stream 120 is composed of between about 10% and about 20% fresh gas to recycled first effluent stream 122. In some embodiments, second influent stream 120 is composed of between about 15% and about 17% fresh gas to recycled first effluent stream 122. In some embodiments, second influent stream 120 is composed of about 16% fresh gas to recycled first effluent stream 122.

Referring specifically to FIGS. 2A and 2D-2E, in some embodiments, system 100 includes a condenser 126 in fluid communication with outlet 112. Condenser 126 converts evaporated solvent from gas phase back to liquid phase. In some embodiments, first effluent stream 122 is provided from outlet 112 to condenser 126. In some embodiments, condenser 126 includes a liquid condenser outlet 126A. In some embodiments, liquid condenser outlet 126A is configured to remove from condenser 126 an amount of a liquid component including an amount of solvent vapor isolated from first effluent stream 122 via a liquid condenser outlet stream 128. In some embodiments, liquid condenser stream 128 has a chemical oxygen demand less than about 100 mg/L. In some embodiments, liquid condenser stream 128 has a chemical oxygen demand less than about 90 mg/L. In some embodiments, liquid condenser stream 128 has a chemical oxygen demand less than about 80 mg/L. In some embodiments, liquid condenser stream 128 has a chemical oxygen demand less than about 70 mg/L. In some embodiments, liquid condenser stream 128 has a chemical oxygen demand less than about 60 mg/L. In some embodiments, liquid condenser stream 128 has a chemical oxygen demand less than about 50 mg/L. In some embodiments, liquid condenser stream 128 has a chemical oxygen demand less than about 40 mg/L. In some embodiments, liquid condenser stream 128 has a chemical oxygen demand less than about 30 mg/L.

In some embodiments, condenser 126 includes a gaseous condenser outlet 126B. In some embodiments, gaseous condenser outlet 126B is configured to remove from condenser 126 an amount of a gaseous component including an amount of gas isolated from first effluent stream 122 via a gaseous condenser outlet stream 130. In some embodiments, gaseous condenser outlet stream 130 is recycled directly to reactor 102 (see FIG. 2D). In some embodiments, gaseous condenser outlet stream 130 is recycled to second influent stream 120 (see FIG. 2E).

In some embodiments of system 100, an oxygen transfer rate to the biomass is equal to or greater than the accumulating biological oxygen demand of the internal reactor volume. In these embodiments, reactor 102 is not overloaded with influent waste products and chemical oxygen demand in first effluent stream 122 is well maintained at about a steady desired level. In some embodiments, a flow rate of the water vapor in the first effluent stream 122 is equal to or greater than a flow rate of first influent stream 118. In these embodiments, system 100 operates a steady state or substantially steady state, with influent volumetric and chemical oxygen demand rates substantially similar and of substantially similar composition. The effluent streams from reactor 102 can be recycled 2 or more times, 3 or more times, 4 or more times, 5 or more times, 6 or more times, 7 or more times, 8 or more times, 9 or more times, 10 or more times, etc. In some embodiments, the contents of the bioreactor is replaced with the solvent and thermophilic biomass after a defined period, e.g., after a total predetermined total volume of influent, predetermined service interval, predetermined number of effluent stream reuse cycles, or combinations thereof. In some embodiments, at least some of the reactor fluid is continuously or on a regular interval, wasted, or removed from system 100. In some embodiments, an additional outlet 112 is included to remove the bioreactor fluids.

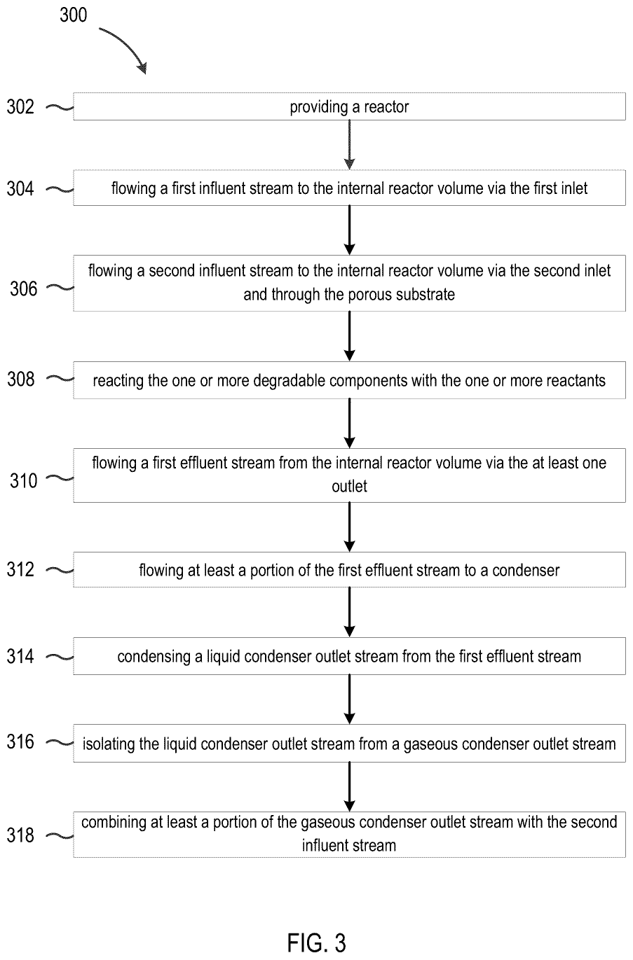

Referring now to FIG. 3, some embodiments of the present disclosure are directed to a method 300 for processing degradable waste. In some embodiments, at 302, a reactor. The reactor at step 302 is consistent with the embodiments of the reactors shown and described above with respect to system 100. In some embodiments, the reactor includes an internal reactor volume, a first inlet in fluid communication with the internal reactor volume, at least one outlet in fluid communication with the internal reactor volume, a second inlet in fluid communication with the internal reactor volume, a biomass positioned in the internal reactor volume, and a porous substrate positioned between the second inlet and the biomass. At 304, a first influent stream is flowed to the internal reactor volume via the first inlet. As discussed above, in some embodiments, the first influent stream includes a liquid composition including one or more degradable components. At 306, a second influent stream is flowed to the internal reactor volume via the second inlet. In some embodiments, the second influent stream is flowed 306 through the porous substrate. In some embodiments, the second influent stream includes a gas composition including one or more reactants. At 308, the one or more degradable components are reacted with the one or more reactants.

At 310, a first effluent stream is flowed from the internal reactor volume via the at least one outlet. As discussed above, in some embodiments, the first effluent stream includes an amount of a solvent vapor. In some embodiments, at least a portion of the first effluent stream is recycled to the reactor. In some embodiments, at 312, at least a portion of the first effluent stream is flowed to a condenser. At 314, a liquid condenser outlet stream is condensed from the first effluent stream. At 316, the liquid condenser outlet stream is isolated from a gaseous condenser outlet stream. At 318, at least a portion of the gaseous condenser outlet stream is combined with the second influent stream, wherein the one or more reactants include oxygen.

In an exemplary embodiment of the systems and methods described above, a waste processing system scaled to process waste from a typical 6 person household was constructed. It was assumed that each member of the household would generate 1.1 stool events per day and 5.4 urine events per day. It was further assumed that each stool event would generate 0.850 L of flush volume, while each urine event would generate half that flush volume. Such flush volumes have been achieved utilizing vacuum toilet frontends. In some embodiments, the toilet providing the stool and/or urine events is flushed using at least a portion of the biomass volume from the reactor, e.g., the volume of biomass 114 described above. The influent volume from flush events (V_{F}) to the reactor of the systems of the present disclosure, e.g., reactor 102 described above, was defined as:

$${V}_{F} = HRT * ( ( {V}_{SE} * {E}_{S} ) + ( {V}_{UE} * {E}_{U} ) )$$

where HRT is the hydraulic retention time, V_{SE} is the volume of liquid per stool event, V_{UE} is the volume of liquid per urine event, E_{S} is the number of stool events per day, and E_{U} is the number of urine events per day. Based on the assumed values for the flush volumes, number of events, and an HRT of 1 day, the influent volume from all flush events was 20.9562 L.

In an effort to operate the reactor at or near steady state, the V_{F} can be balanced by the flow of humid gas out of the reactor, i.e., first effluent stream 122 described above. The aeration flow rate (Qₐᵢᵣ) into the reactor that is necessary to evaporate V_{F} in HRT time was defined as:

$${Q}_{air} = \frac{{V}_{F}}{MCC * HRT}$$

where MCC is the moisture carrying capacity of the effluent at the operating temperature of the reactor. The effluent stream was assumed to be predominantly humid air, which at 60° C. has an MCC of 0.13 kgH₂O/m³air. Based on these assumed values, the aeration flow rate was 0.001866 m³/s.

The next consideration was how much oxygen needs to be delivered by the Qₐᵢᵣ in order to reduce the chemical/biological oxygen demand provided by V_{F} during the HRT. The oxygen transferred (OT) by the biomass was defined as:

$$OT = {k}_{L} a * {DO}_{sat} * \int V ( t ) dt = {k}_{L} a * 5.4 mg / L * 1 day * ( {V}_{R} + {V}_{F} / 2 )$$

where k_{L}a is the volumetric mass transfer coefficient, i.e., aeration efficiency, in the biomass, DOₛₐₜ is the concentration of dissolved oxygen in the biomass component at saturation at the operating temperature of the reactor, and V_{R} is the bioreactor retained volume. If OT insufficiently reduces chemical oxygen demand, k_{L}a and/or V_{R} can be increased.

k_{L}a was assumed to be set by the superficial gas velocity (U_{G}) in the reactor, defined as:

$${U}_{G} = \frac{{Q}_{air}}{A}$$

where A is the cross-sectional area of the cylindrical reactor, definable as V_{F}+V_{R}/H, the height of the reactor. As a result, k_{L}a can be defined as:

$${k}_{L} a = 0.466 {( \frac{{Q}_{air}}{A} )}^{0.732}$$

In this exemplary embodiment, it was assumed, per capita per day, 243 g wet mass stool and 8 g toilet paper for stool events, 22 g toilet paper for urine events, resulting in a daily chemical oxygen demand accumulation of 766.020 g. In order to enable sufficient oxygen transfer to address the chemical oxygen demand, V_{R} could be set to 28.085 L. The overall size of the reactor capable of processing the wastes generated by a typical 6 person household can be just 1 meter tall and about 10 inches in diameter, which is a very reasonable size.

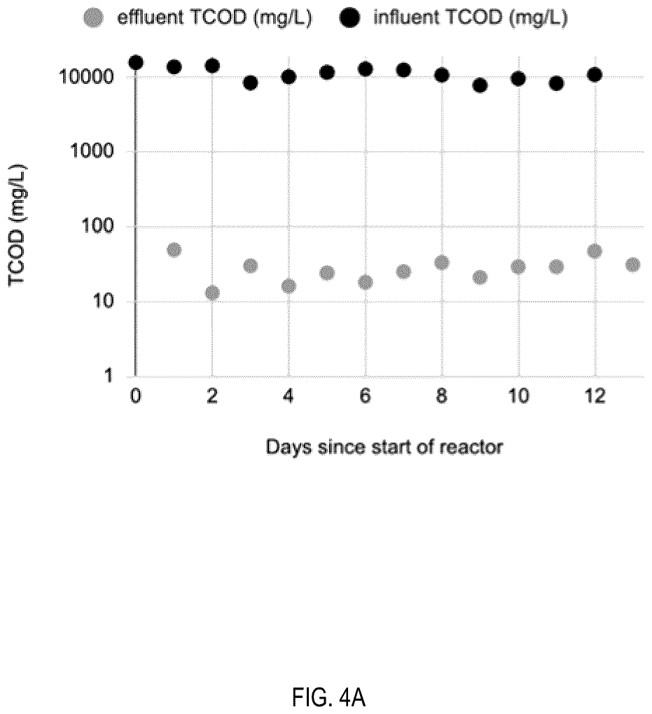

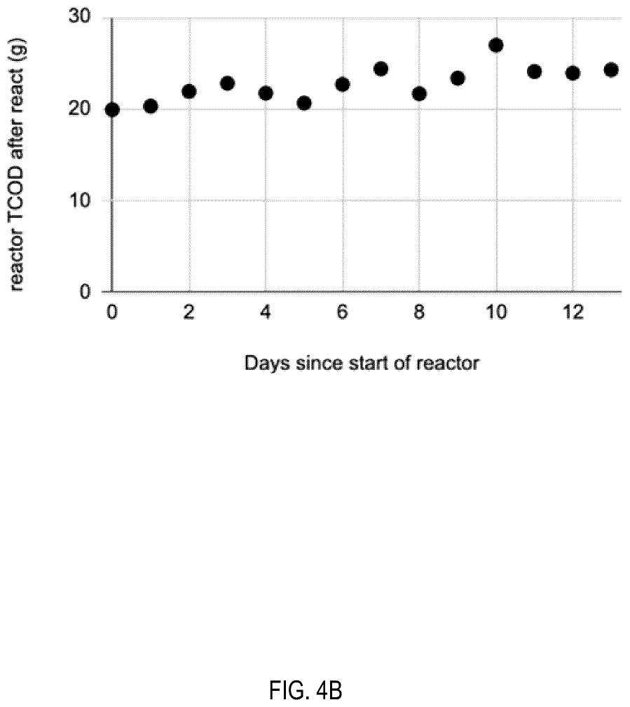

Referring now to FIGS. 4A-4B, a 1:60 scale system of the 6 person household design described above was constructed and tested. The effluent quality was high, averaging 28 mg/L COD and 1.2 mg/L TSS. Referring specifically to FIG. 4B, reactor COD slowly increased, at an accumulation rate 6% of the influent loading rate.

Without wishing to be bound by theory, the exemplary embodiment discussed above use an amount of energy from transferring water from the liquid bioreactor phase to the aeration gas phase, equivalent to the latent heat of vaporization of the total influent water volume, although aerobic thermophiles yield heat in their metabolism, thereby providing an amount of self-heating the process.

For example, for the composition described above for 6 persons per day, 94% of 766 g_{COD} yields 116 W thermal energy from its digestion by aerobic thermophiles at 13.9 kJ/g_{O2} delivered, assuming all O₂ is directly used for metabolism of COD. Use of a 95% efficient heater to evaporate all the water in the daily 6 person influent per day uses 538 W for the above composition of influent. Power from a compressor may also be used, which equals the hydrostatic pressure of the bubble column height (ρgh) multiplied by aeration flow rate and the inverse of power efficiency. A 70% efficient compressor can use about 26 W. Converting to dollars using $0.15/kWh electricity, this 6 person system uses $1.61/day.

In an exemplary embodiment, a recirculating air system was implemented which recirculates humidified air back through the bioreactor. Without wishing to be bound by theory, because 100% relative humidity is achieved in a single pass, while only 1.8% of oxygen is transferred from the air to the fluid in a single pass, the evaporation can be reduced while maintaining similar oxygen transfer rates. This also accommodates the non-fouling coarse bubble column reactor design.

In this exemplary embodiment, the air was recirculated four times through the fluid. (1−0.982⁴)=0.07 of the oxygen present in the air was delivered, achieving an average efficiency of 1.75%, a loss of 2.7% from the original 1.8%. Thus, the power for evaporation was reduced by 75%, while compressor power increased by only 2.7%, and the same metabolic heat yield was maintained. In this heuristic process, an electricity use of 45 W, or $0.16/day, was achieved. A similar energy reduction usage can be achieved by another embodiment, to avoid moving parts to switch between recirculated and fresh air, a system which continuous brings in a fresh fraction of air.

With specific reference to FIG. 2C, to avoid moving parts to switch between recirculated and fresh air, a system which continuously brings in a fresh fraction of air and utilizes a compressor along second influent stream 120 was constructed, incurring no increased capital cost in the bioreactor build. The fresh fraction (f) was defined as the amount of stream 125 over the total amount of stream 125 and first effluent stream 122, the power used by the heater, P_{H}, and the power used by the compressor to circulate air, P_{C}, were calculated.

A 70% efficient air compressor and a 95% efficient electrical heater were used. The power used by the heater is directly proportional to gas exiting the system from second influent stream 120, and therefore f, and the offset from a zero-intercept comes from the heat yield of the thermophiles. Without wishing to be bound by theory, the power used by the compressor increases without bound as f goes to 0; with no fresh air, an infinite speed first effluent stream 122 is required to transfer sufficient oxygen. Since negative heater power implies required cooling, the system of the exemplary embodiment can be operated at P_{H}=0, with f=0.16, and 32 W electrical, achieving $0.12/day and 130 mL stool flush volume.

As used herein, the term “about” generally means plus or minus about 10% of the stated value.

Methods and systems of the present disclosure are advantageous to provide a system capable of simultaneous chemical reaction between a number of liquid and gaseous phase reactants and removal of solvent to dry the reactor volume. Thus, the systems and methods of the present disclosure can simultaneously process waste and separate solvent from other reactor contents, e.g., biomass, solids, etc., without the use of a separation system, e.g., a clarifier, membrane, etc., either as a separate system or attached after an outlet for the reactor contents. The invention described is both effective, producing a high quality effluent, and low cost, without the need for chemicals to flocculate or scour membranes. Such systems are shown to be suitable for processing organic solid waste and generating a clean effluent via an auto-thermal aerobic digestion process. Solid wastes, such as stool and toilet paper, are supplied to a thermophilic biomass in a reactor and aerated, resulting in degradation of the solid waste and generating a humid air effluent stream and a fertilizer. Upon exit from the reactor, the water vapor in the effluent stream is condensed as liquid water as it is cooled in temperature, rather than through conventional solid-liquid separation methods such as settling or membrane filtration which is prone to fouling. This forms the liquid effluent of the process, which is clear and includes minimal levels of chemical oxygen demand and ammoniacal nitrogen. A gaseous component from the humid air effluent stream can then be recycled to the biomass for further aeration thereof.

As a result, this technology has the potential to improve the efficiency of extracting resources from a wide variety of organic solid wastes, although the systems and methods of the present disclosure are simple enough for use as a consumer device. The embodiments of the present disclosure provide a route to reducing costs for multiple industries, including municipal-scale wastewater treatment process, generating fertilizer from municipal waste, composting toilets for consumers, solid-liquid separation technology, wastewater and sewage treatment, landfill waste treatment, composting applications, large-scale chemical manufacturing, membrane bioreactors, agricultural and animal waste treatment, machine engine fuel aerator, etc. The embodiments of the present disclosure can also be applied in biotechnology applications, where organisms are grown under aerobic conditions in order to produce compounds.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for processing reactants, comprising:
a reactor including:
an internal reactor volume;
a first inlet in fluid communication with the internal reactor volume, the first inlet configured to receive a liquid influent stream including a first reactant;
at least one outlet in fluid communication with the internal reactor volume, the at least one outlet configured to remove a first gaseous effluent stream including an amount of solvent vapor, and
a second inlet in fluid communication with the internal reactor volume, the second inlet configured to receive a gaseous influent stream including a second reactant.

2. The system according to claim 1, further comprising:
a biomass positioned in the internal reactor volume;
a porous substrate positioned between the second inlet and the biomass;
a liquid influent stream in fluid communication with the first inlet, the liquid influent stream including an aqueous composition and the first reactant including one or more degradable components;
a first gaseous effluent stream in fluid communication with the at least one outlet, the solvent vapor including water; and
a gaseous influent stream in fluid communication with the second inlet, the gaseous influent stream including a gas composition including the second reactant, the second reactant including oxygen.

3. The system according to claim 2, wherein the porous substrate includes a plurality of orifices having an average diameter between about 1 mm and about 300 mm.

4. The system according to claim 2, wherein the degradable components include stool, toilet paper, urine, food waste, industrial waste, agricultural waste, or combinations thereof.

5. The system according to claim 2, wherein the gas composition includes air, pure oxygen, or combinations thereof.

6. The system according to claim 5, wherein the gas composition includes a fresh gas stream, at least a portion of the first gaseous effluent stream, or combinations thereof.

7. The system according to claim 2, wherein the biomass includes a plurality of thermophilic bacteria.

8. The system according to claim 7, wherein the thermophilic bacteria include firmicutes, deinococcus-thermus, proteobacteria, gemmatimonadetes, chloroflexi, bacteroidetes, actinobacteria, cyanobacteria, verrucomicrobia, acidobacteria, planctomycetes, euryarchaeota, or combinations thereof.

9. The system according to claim 2, wherein the temperature in the internal reactor volume is maintained between about 40° C. and about 80° C.

10. The system according to claim 1, further comprising:
a condenser in fluid communication with the at least one outlet, the condenser including:
a liquid condenser outlet configured to remove from the condenser an amount of a liquid component including an amount of solvent vapor; and
a gaseous condenser outlet configured to remove from the condenser an amount of a gaseous component including an amount of a first gaseous effluent stream.

11. The system according to claim 10, wherein the gaseous condenser outlet is in fluid communication with the internal reactor volume.

12. A method for processing degradable waste, comprising:
providing a reactor, the reactor including:
an internal reactor volume;
a first inlet in fluid communication with the internal reactor volume;
at least one outlet in fluid communication with the internal reactor volume;
a second inlet in fluid communication with the internal reactor volume;
a biomass positioned in the internal reactor volume, and
a porous substrate positioned between the second inlet and the biomass,
flowing a first influent stream to the internal reactor volume via the first inlet, the first influent stream including a liquid composition including one or more degradable components;
flowing a second influent stream to the internal reactor volume via the second inlet and through the porous substrate, the second influent stream including a gas composition including one or more reactants;
reacting the one or more degradable components with the one or more reactants, and
flowing a first effluent stream from the internal reactor volume via the at least one outlet, the first effluent stream including an amount of a solvent vapor.

13. The method according to claim 12, further comprising:
flowing at least a portion of the first effluent stream to a condenser;
condensing a liquid condenser outlet stream from the first effluent stream, and
isolating the liquid condenser outlet stream from a gaseous condenser outlet stream.

14. The method according to claim 13, further comprising:
combining at least a portion of the gaseous condenser outlet stream with the second influent stream,
wherein the one or more reactants include oxygen.

15. The method according to claim 12, wherein the porous substrate includes a plurality of orifices having an average diameter between about 1 mm and about 300 mm.

16. The method according to claim 12, wherein the degradable components include stool, toilet paper, urine, food waste, industrial waste, agricultural waste, or combinations thereof.

17. The method according to claim 12, wherein the biomass includes a plurality of thermophilic bacteria including firmicutes, deinococcus-thermus, proteobacteria, gemmatimonadetes, chloroflexi, bacteroidetes, actinobacteria, cyanobacteria, verrucomicrobia, acidobacteria, planctomycetes, euryarchaeota, or combinations thereof.

18. A system for processing degradable waste, comprising:
a reactor including:
a bubble distributor positioned within the reactor and defining an internal reactor volume between the bubble distributor and an opposing end of the reactor, the bubble distributor including a plurality of substantially evenly distributed orifices extending therethrough, the orifices having a diameter between about 1 mm and about 300 mm;
a first inlet in fluid communication with the internal reactor volume;
at least one outlet in fluid communication with the internal reactor volume;
a second inlet in fluid communication with the internal reactor volume, and
a biomass positioned in the internal reactor volume, the biomass including a plurality of thermophilic bacteria,
a first influent stream in fluid communication with the first inlet, the first influent stream including an aqueous composition including one or more degradable components;
a first gaseous effluent stream in fluid communication with the at least one outlet, the first gaseous effluent stream including an amount of water vapor;
a second influent stream in fluid communication with the second inlet, the second influent stream including a gas composition including an oxygen component;
a heat source configured to maintain the internal reactor volume at a temperature between about 40° C. and about 80° C.;
a condenser in fluid communication with the first gaseous effluent stream;
a liquid condenser outlet stream in fluid communication with the condenser, the liquid condenser stream including an amount of a liquid component isolated from the first gaseous effluent stream and having a chemical oxygen demand less than about 30 mg/L, and
a gaseous condenser outlet stream in fluid communication with the condenser and the second influent stream, the gaseous condenser stream comprising a gaseous component isolated from the first gaseous effluent stream,
wherein the second influent stream includes the gaseous condenser outlet stream and an amount of air.

19. The system according to claim 18, wherein the thermophilic bacteria include firmicutes, deinococcus-thermus, proteobacteria, gemmatimonadetes, chloroflexi, bacteroidetes, actinobacteria, cyanobacteria, verrucomicrobia, acidobacteria, planctomycetes, euryarchaeota, or combinations thereof.

20. The system according to claim 18, wherein:
an oxygen transfer rate to the biomass is equal to or greater than the accumulating biological oxygen demand of the internal reactor volume, and
a flow rate of the water vapor in the first gaseous effluent stream is equal to or greater than a flow rate of the first influent stream.
